(19) United States
(12) Patent Application Publication
(10) Pub. No.: US 2026/0280298 A1
(43) Pub. Date: Sep. 17, 2026

(54) COMPUTER-IMPLEMENTED METHOD FOR MANAGING DISTRIBUTED ENERGY STORAGE SYSTEM

(71) Applicant: ELISA OYJ, Helsinki (FI)

(72) Inventors: Jukka-Pekka SALMENKAITA, Helsinki (FI); Esko HEINONEN, Helsinki (FI); Simon HOLMBACKA, Helsinki (FI)

(73) Assignee: ELISA OYJ, Helsinki (FI)

(21) Appl. No.: 19/469,223

(22) PCT Filed: Dec. 18, 2023
(86) PCT No.: PCT/FI2023/050706

§ 371 Date: Sep. 25, 2025

(30) Foreign Application Priority Data
Mar. 29, 2023 (FI) 20235360

(51) Int. Cl. H02J 3/32; H02J 3/0014; H02J 3/46

(52) U.S. Cl. CPC H02J 3/32; H02J 3/00142; H02J 3/46

(57) ABSTRACT

According to an embodiment, a computer-implemented method for managing a distributed energy storage system comprising a plurality of nodes coupled to a power grid, wherein each node comprises at least one energy storage, comprises: receiving an activation signal for power grid frequency balancing comprising a frequency balancing capacity requirement; selecting nodes out of the plurality of nodes to be activated and/or deactivated for the power grid frequency balancing according to the frequency balancing capacity requirement; activating and/or de-activating the selected nodes for the power grid frequency balancing; monitoring, during the power grid frequency balancing, whether a power quantity of the selected nodes deviates from the frequency balancing capacity requirement; and in response to the power quantity deviating from the frequency balancing capacity requirement, reselecting nodes out of the plurality of nodes to be activated and/or deactivated for the power grid frequency balancing according to the frequency balancing capacity requirement.

### TECHNICAL FIELD

The present disclosure relates to distributed energy storage systems, and more particularly to a computer-implemented method for managing a distributed energy storage system, a computing device, a distributed energy storage system, and a computer program product.

### BACKGROUND

A distributed energy storage (DES) can comprise a large number of nodes, and each node can be powered by, for example, the power grid or by a battery system connected to the node. When working in national frequency reserve markets, the market operator can require each participant to deliver a selected amount of frequency balancing capacity for the market during the time of resource activation. The activated frequency balancing capacity is usually not allowed to fluctuate significantly from its intended setpoint, and sanctions against the participants can be put in case the participant is not able to deliver steady capacity for the market.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a computer-implemented method for managing a distributed energy storage system, a computing device, a distributed energy storage system, and a computer program product. The foregoing and other objectives are achieved by the features of the independent claims. Further implementation forms are apparent from the dependent claims, the description and the figures.

According to a first aspect, a computer-implemented method for managing a distributed energy storage system comprising a plurality of nodes coupled to a power grid, wherein each node comprises at least one energy storage, comprises: receiving an activation signal for power grid frequency balancing comprising a frequency balancing capacity requirement; selecting nodes out of the plurality of nodes to be activated and/or deactivated for the power grid frequency balancing according to the frequency balancing capacity requirement; activating and/or deactivating the selected nodes for the power grid frequency balancing; monitoring, during the power grid frequency balancing, whether a power quantity of the selected nodes deviates from the frequency balancing capacity requirement, wherein the power quantity is based on a measurement of the at least one energy storage of each node in the selected nodes; and in response to the power quantity deviating from the frequency balancing capacity requirement, reselecting nodes out of the plurality of nodes to be activated and/or deactivated for the power grid frequency balancing according to the frequency balancing capacity requirement. The method can, for example, ensure that the distributed energy storage system keeps fulfilling the frequency balancing capacity requirement.

In an implementation form of the first aspect, the power quantity deviating from the frequency balancing capacity requirement comprises a deviation between the power quantity and the frequency balancing capacity requirement being greater than a preconfigured deviation threshold value. The method can, for example, efficiently detect when the power quantity deviates from the frequency balancing capacity requirement.

In another implementation form of the first aspect, the selecting nodes out of the plurality of nodes to be activated and/or deactivated for the power grid frequency balancing according to the frequency balancing capacity requirement comprises: selecting the nodes out of the plurality of nodes according to a frequency balancing capacity of each node in the plurality of nodes. The method can, for example, efficiently select nodes out of the plurality of nodes to be activated and/or deactivated for the power grid frequency balancing according to the frequency balancing capacity requirement.

In another implementation form of the first aspect, the selecting the nodes out of the plurality of nodes according to the frequency balancing capacity of each node in the plurality of nodes comprises: obtaining the frequency balancing capacity of each node in the plurality of nodes from a frequency balancing capacity database. The method can, for example, efficiently select the nodes out of the plurality of nodes based on the frequency balancing capacity of each node obtained from the frequency balancing capacity database.

In another implementation form of the first aspect, the reselecting nodes out of the plurality of nodes to be activated and/or deactivated for the power grid frequency balancing according to the frequency balancing capacity requirement comprises: in response to an aggregate of the power quantity of the selected nodes being less than the frequency balancing capacity requirement, increasing a number of nodes in the selected nodes; and/or in response to an aggregate of the power quantity of the selected nodes being greater than the frequency balancing capacity requirement, decreasing a number of nodes in the selected nodes. The method can, for example, appropriately reselect nodes out of the plurality of nodes when the aggregate of the power quantity of the selected nodes is less or greater than the frequency balancing capacity requirement.

In another implementation form of the first aspect, the monitoring whether the power quantity of the selected nodes deviates from the frequency balancing capacity requirement comprises obtaining the power quantity of each node in the selected nodes from a power quantity database. The method can, for example, efficiently monitor whether the power quantity of the selected nodes deviates from the frequency balancing capacity requirement based on the power quantity of each node in the selected nodes obtained from the power quantity database.

In another implementation form of the first aspect, at least one energy storage comprises at least one battery. The method can, for example, ensure that the distributed energy storage system keeps fulfilling the frequency balancing capacity requirement even when properties of at least one battery of the nodes cause the power quantity of the selected nodes to deviate from the frequency balancing capacity requirement.

In another implementation form of the first aspect, activating the selected nodes for the power grid frequency balancing comprises: in response to the frequency balancing capacity requirement corresponding to up regulation of the power grid, powering each node of the selected nodes using the at least one energy storage of the node and/or feeding power to the power grid from the at least one energy storage of the node; and/or in response to the frequency balancing capacity requirement corresponding to down regulation of the power grid, charging the at least one energy storage of each node in the selected nodes using power from the power grid. The method can, for example, ensure that the distributed energy storage system keeps fulfilling the frequency balancing capacity requirement when the frequency balancing capacity requirement corresponding to up or down regulation of the power grid.

In another implementation form of the first aspect, each node in the plurality of nodes comprises a rectifier for charging at least one energy storage using power from the power grid; and/or each node in the plurality of nodes comprises an inverter for feeding power to the power grid from the at least one energy storage. The method can, for example, efficiently fulfil the frequency balancing capacity requirement by controlling power between the at least one energy storage of the nodes and the power grid.

In another implementation form of the first aspect, the power quantity comprises a current and a voltage of at least one energy storage. The method can, for example, efficiently detect when the selected nodes cannot fulfil the frequency balancing capacity requirement.

In another implementation form of the first aspect, the power quantity comprises a product of a current and a voltage of at least one energy storage. The method can, for example, efficiently detect when the selected nodes cannot fulfil the frequency balancing capacity requirement.

According to a second aspect, a computing device comprises at least one processor and at least one memory including computer program code, the at least one memory and the computer program code being configured to, with the at least one processor, cause the computing device to perform the method according to the first aspect.

According to a third aspect, a distributed energy storage system comprises a plurality of nodes coupled to a power grid, wherein each node comprises at least one energy storage, and the computing device according to the second aspect.

According to a fourth aspect, a computer program product comprises program code configured to perform the method according to the first aspect when the computer program product is executed on a computer.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a flow chart representation of a method according to an embodiment;

FIG. 2 illustrates a schematic representation of a node according to an embodiment;

FIG. 3 illustrates a plot representation of DES system power consumption according to an embodiment;

FIG. 4 illustrates a plot representation of activated frequency balancing capacity according to an embodiment;

FIG. 5 illustrates a flow chart representation of a procedure according to an embodiment;

FIG. 6 illustrates a schematic representation of databases according to an embodiment;

FIG. 7 illustrates a schematic representation of a computing device according to an embodiment; and

FIG. 8 illustrates a schematic representation of a distributed energy storage system according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

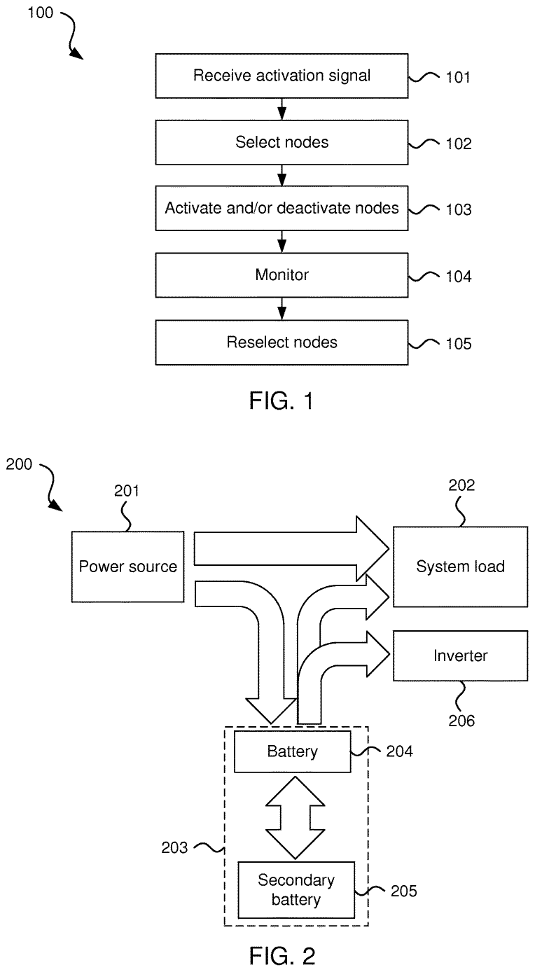

FIG. 1 illustrates a flow chart representation of a method according to an embodiment.

According to an embodiment, a computer-implemented method 100 for managing a distributed energy storage system comprising a plurality of nodes coupled to a power grid, wherein each node comprises at least one energy storage, comprises receiving 101 an activation signal for power grid frequency balancing comprising a frequency balancing capacity requirement.

The at least one energy storage can comprise, for example, at least one battery.

A distributed energy storage (DES) can comprise a large number of nodes, and each node can be powered by, for example, the power grid or by a battery system connected to the node.

The activation signal may be provided by, for example, a grid operator. When working in national frequency reserve markets, the grid operator can require each participant to deliver a selected amount of frequency balancing capacity for the market during the time of resource activation. The activated frequency balancing capacity is usually not allowed to fluctuate significantly from its intended setpoint, and the participants can be sanctioned in case the participant is not able to deliver steady frequency balancing capacity for the market.

The method 100 may further comprise selecting 102 nodes out of the plurality of nodes to be activated and/or deactivated for the power grid frequency balancing according to the frequency balancing capacity requirement.

Herein, selecting 102 nodes out of the plurality of nodes to be activated and/or deactivated for the power grid frequency balancing may comprise configuring which nodes are used for the power grid frequency balancing. For example, when a node is activated for the power grid frequency balancing, the node can be configured to, for example, in the case of up regulation, feed power to the power grid from the at least one energy storage of the node or to, in the case of down regulation, charge the at least one energy storage of the node using power from the power grid.

The method 100 may further comprise activating and/or deactivating 103 the selected nodes for the power grid frequency balancing.

Battery operated nodes can require charging and discharging actions of the batteries to deliver up and down regulation to the market. A problem can occur when, for example, the battery is not able to charge or discharge fully according to its specification. For example, once the battery voltage drops beyond a certain limit, the battery may not be able to deliver enough current to drive the system load of the node and the power source of the node may need to be activated to assist the battery. This can in turn affect the frequency balancing capacity of the node. In the same fashion, the charging current can be limited when, for example, batteries are almost full, the ambient temperature is too high/low, and/or other factors limit the charging of the batteries.

Further, since batteries of different chemistries, ages, vendors etc. behave differently, it may not be feasible to make simple heuristics for controlling the batteries in a completely predictable way. Alternatively or additionally, the nodes could comprise other power source, such as solar power, the output power of which may be difficult to predict.

The method 100 may further comprise monitoring 104, during the power grid frequency balancing, whether a power quantity of the selected nodes deviates from the frequency balancing capacity requirement, wherein the power quantity is based on a measurement of the at least one energy storage of each node in the selected nodes.

Since the power quantity is based on a measurement of the at least one energy storage of each node in the selected nodes, the power quantity can more accurately reflect the frequency balancing capacity of the selected nodes.

The method 100 may further comprise, in response to the power quantity deviating from the frequency balancing capacity requirement, reselecting 105 nodes out of the plurality of nodes to be activated and/or deactivated for the power grid frequency balancing according to the frequency balancing capacity requirement.

The method 100 can utilise a feedback mechanism that uses real measurements between node battery, power source and load to adjust the real activated frequency balancing capacity seen from the grid operator's point of view. The method 100 can, for example, enable the market participants to deliver stable frequency balancing capacity activation to the grid.

According to an embodiment, the power quantity deviating from the frequency balancing capacity requirement comprises a deviation between the power quantity and the frequency balancing capacity requirement being greater than a preconfigured deviation threshold value.

The preconfigured deviation threshold value may be, for example, preconfigured by an administrator of the distributed energy storage system.

According to an embodiment, the selecting 102 nodes out of the plurality of nodes to be activated and/or deactivated for the power grid frequency balancing according to the frequency balancing capacity requirement comprises selecting the nodes out of the plurality of nodes according to a frequency balancing capacity of each node in the plurality of nodes.

FIG. 2 illustrates a schematic representation of a node according to an embodiment.

Each node 200 can comprise at least one power source 201. The power source 201 can be, for example, electrically coupled to the power grid. Alternatively or additionally, the power source 201 may comprise some other type of power source, such as a renewable energy power source. For example, the power source 201 may comprise at least one solar panel, at least one wind turbine, and/or similar.

According to an embodiment, each node 200 in the plurality of nodes comprises a rectifier for charging the at least one energy storage using power from the power grid and/or each node 200 in the plurality of nodes comprises an inverter for feeding power to the power grid from the at least one energy storage.

For example, if the node 200 comprises a direct current (DC) system, such as in the embodiment of FIG. 2, the at least one power source 201 can comprise at least one rectifier for converting the alternating current (AC) to DC compatible with the node 200. For example, at least one rectifier can convert 230-volt AC to 48-volt DC. At least one power source 201 can be used to drive a system load 202. At least one power source 201 can also be used to provide power to at least one energy storage 203.

According to an embodiment, the at least one energy storage 203 comprises at least one battery.

In other embodiments, the at least one energy storage 203 may comprise alternatively or additionally, for example, a capacitor, a supercapacitor, and/or similar.

For example, in the embodiment of FIG. 2, the at least one energy storage 203 comprises a main battery 204 and a secondary battery 205. The secondary battery 205 can comprise, for example, a battery of an electric vehicle. The secondary battery 205 can be connected, for example, in parallel with the main battery 204 for bi-directional charging. When the secondary battery 205 is connected, it can provide additional current to the node 200 on demand to meet the system load 202 or inverter 206 requirements.

The rectifier can be “partly” used if the terminal voltage of the rectifier is set slightly lower than the battery voltage. In such a configuration, some current is drawn to the system load 202 from the rectifier and some from the battery.

The at least one energy storage 203 can be used to drive the system load 202 when being controlled to, and to receive charge from the power source 201 during recharge periods. The current from/to the at least one energy storage 203 is not always its theoretical maximum due to various factors, such as those disclosed herein. The method 100 and various embodiments disclosed herein can take this into account in the power grid frequency balancing.

The system load 202 can comprise, for example, various equipment consuming power, the type of the equipment can be essentially anything consuming electricity. If the power source 201 is partly pushing current to the system load 202, the frequency balancing capacity for up regulation of the node 200 may not be equal to its power consumption but less.

For example, the node 200 may be embodied in a base station of a telecommunication network. The system load 202 may comprise equipment of the base station. The at least one energy storage 203 can be used for power redundancy of the base station in addition to power grid frequency balancing.

The node 200 can further comprise at least one inverter 206 that can be electrically coupled to the at least one energy storage 203 and to the power grid. The at least one inverter 206 can be used to push electricity back to the power grid from the at least one energy storage 203.

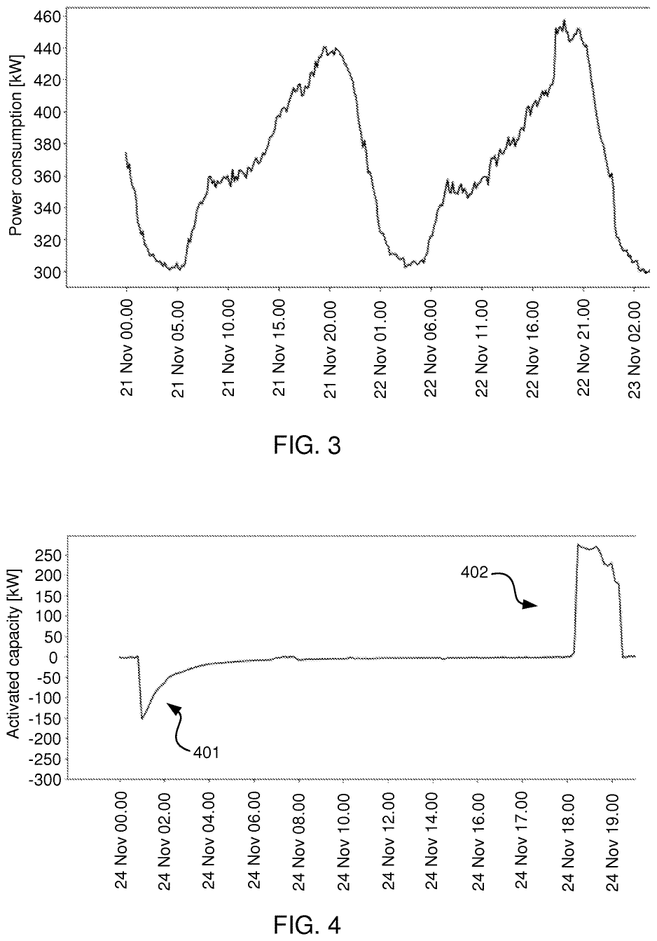

FIG. 3 illustrates a plot representation of DES system power consumption according to an embodiment.

Reserve market operators can send activation signals for power grid frequency balancing to the participants. The activation signal can request for a certain frequency balancing capacity from the DES system, such as +1 MW.

The participant can select enough nodes so that the aggregate frequency balancing capacity of the selected nodes corresponds to what the market operator is requesting.

The node selection process can be the following for up regulation:
1. Obtain a historical power consumption of the system load of each node 200.
2. Select enough nodes so that the aggregate power consumption as close as possible to the frequency balancing capacity requirement. The power consumption of each node 200 may be used as the frequency balancing capacity of the node 200.
3. Activate the selected nodes so that they are powered by batteries instead of rectifiers.

The node selection process can be the following for down regulation:
1. Fetch a historical power consumption of the system load and the maximum rectifier capacity of each node 200.
2. Select enough nodes to that the aggregate frequency balancing capacity is as close as possible the requested frequency balancing capacity. The aggregated frequency balancing capacity can be calculated as a subtraction between the maximum rectifier capacity and the power of the system load, i.e., MAX_RECTIFIER_CAPACITY—SysPower. The maximum rectifier capacity can be limited by, for example, the maximum physical properties in the power equipment or by software limitations in the power equipment.

The steps disclosed above can be used to calculate a theoretical frequency balancing capacity for power grid frequency balancing for a DES system. However, due to the aforementioned dynamic situations, the allocated power grid frequency balancing capacity may not always be constant for the whole activation period.

According to an embodiment, the activating and/or deactivating 103 the selected nodes for the power grid frequency balancing comprises: in response to the frequency balancing capacity requirement corresponding to up regulation of the power grid, powering each node of the selected nodes using the at least one energy storage of the node and/or feeding power to the power grid from the at least one energy storage of the node; and/or in response to the frequency balancing capacity requirement corresponding to down regulation of the power grid, charging the at least one energy storage of each node in the selected nodes using power from the power grid.

FIG. 4 illustrates a plot representation of activated frequency balancing capacity according to an embodiment.

The embodiment of FIG. 4 illustrates examples of down and up regulation. For up regulation, FIG. 4 illustrates the power flowing out of the at least one energy storage 203 of the nodes 200 of a DES system, and for down regulation, the power flowing into the at least one energy storage 203 of the nodes 200 of a DES system.

Section 401 corresponds to down regulation which starts at approximately −150 kw, but gradually decreases once the batteries of the nodes 200 are close to fully charged.

Section 402 corresponds to up regulation which starts at approximately 300 kW, but after about half an hour, the voltage of some of the batteries start to drop and the rectifier units need to compensate with grid power. This leads to a drop in the power grid frequency balancing capacity of the DES system at the end of the hour.

In order to compensate for the node selection, the method 100 can monitor the power quantity. The power quantity can comprise the current, measured in amperes (A), of the at least one energy storage 203 together with the voltage, measured in volts (V), of the at least one energy storage 203 to better reflect the real frequency balancing capacity of each node 200.

According to an embodiment, the power quantity comprises a current and a voltage of at least one energy storage.

According to an embodiment, the power quantity comprises a product of a current and a voltage of at least one energy storage.

For example, the power quantity may comprise the product of a voltage of the at least one energy storage 203 and a current flowing in/out of the at least one energy storage 203, i.e. Voltage*Current. The unit of this quantity may be volt-ampere (VA), and the quantity may be referred to as “VApower”.

When VApower is significantly different from the frequency balancing capacity requirement, the method 100 can activate/deactivate additional nodes to compensate for the difference.

The VApower feedback can also be relevant during down regulation because of declining charging current once batteries are close to fully charged as seen in the section 401 of FIG. 4. When the real frequency balancing capacity for down regulation, reflected by the power quantity, declines, the method 100 can activate more nodes for down regulation to compensate.

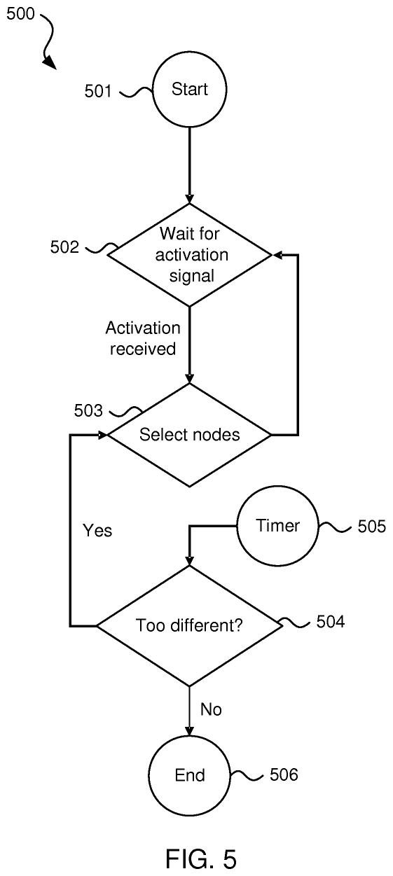

FIG. 5 illustrates a flow chart representation of a procedure according to an embodiment.

A system can follow the flow chart illustrated in the embodiment of FIG. 5 to implement the method 100.

In operation 501, the procedure 500 can start.

In operation 502, the procedure 500 can wait for the activation signal for power grid frequency balancing.

In operation 503, in response to receiving the activation signal for power grid frequency balancing, the procedure 500 can calculate how many nodes are needed for the activation signal and select the nodes to be activated. The procedure can the return to operation 502 to wait for a new activation signal.

A timer 505 or event can trigger a monitor task for checking 504 if the power quantity is different enough from the requested capacity.

If the power quantity is not different enough from the requested frequency balancing capacity, the monitoring task can end 506.

If the power quantity is different enough from the requested frequency balancing capacity, the node selection operation 503 can be used to select additional nodes or disable some nodes.

The monitoring can comprise a hysteresis value for activating new node so that minor fluctuations are not frequently affecting the operations.

According to an embodiment, the reselecting 105 nodes out of the plurality of nodes to be activated and/or deactivated for the power grid frequency balancing according to the frequency balancing capacity requirement comprises: in response to an aggregate of the power quantity of the selected nodes being less than the frequency balancing capacity requirement, increasing a number of nodes in the selected nodes; and/or in response to an aggregate of the power quantity of the selected nodes being greater than the frequency balancing capacity requirement, decreasing a number of nodes in the selected nodes.

The aggregate of the power quantity of the selected nodes may comprise, for example, an aggregated power quantity obtained by summing the power quantity of each node 200 in the selected nodes.

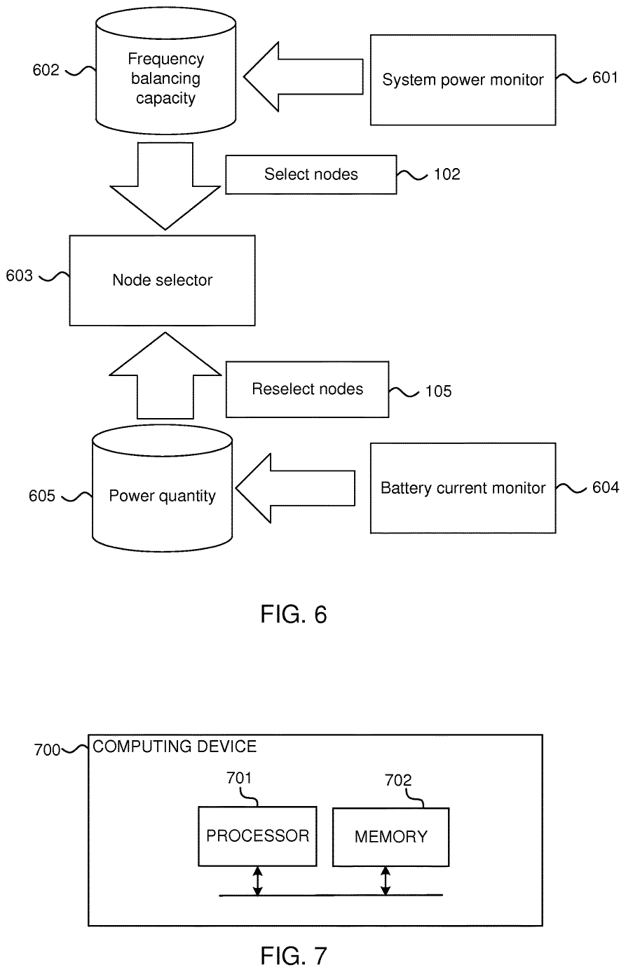

FIG. 6 illustrates a schematic representation of databases according to an embodiment.

According to an embodiment, the selecting the nodes out of the plurality of nodes according to the frequency balancing capacity of each node in the plurality of nodes comprises obtaining the frequency balancing capacity of each node in the plurality of nodes from a frequency balancing capacity database.

Herein, “obtaining” may comprise, for example, obtaining the data in question from memory, performing some processing and obtaining the data as a result of the processing, receiving the data from a function/method/device/module, reading a file containing audio data, and/or similar.

For example, in the embodiment of FIG. 6, the power consumption of the system load 202 of each node 200 can be measured by a system power monitor 601. The power consumption of the system load 202 of each node 200 can be stored in the frequency balancing capacity database 602. Alternatively, some other quantity can be used as the frequency balancing capacity of each node and stored in the frequency balancing capacity database 602.

A node selector 603 can select 102 nodes out of the plurality of nodes to be activated and/or deactivated for the power grid frequency balancing according to the frequency balancing capacity database 602.

According to an embodiment, the monitoring 104 whether the power quantity of the selected nodes deviates from the frequency balancing capacity requirement comprises obtaining the power quantity of each node in the selected nodes from a power quantity database.

For example, in the embodiment of FIG. 6, the battery current of the at least one battery of each node 200 can be monitored by a battery current monitor 604. Additionally or alternatively, the battery current monitor 604 can monitor the VApower of the at least one battery of each node 200. The battery current and/or VApower each node 200 can be stored in the power quantity database 605. Alternatively, some other quantity can be used as the power quantity of each node 200 and stored in the power quantity database 602.

In some embodiments, other quantities can be used. One example of other quantity that may be used is ReadPower. This may be especially useful when doing initial node selection and not being able to calculate the VApower for nodes in certain state. ReadPower can comprise a measurement of the power consumption of the system load 202 of the node 200. Since the power consumption can be constantly present on all nodes, this value can be used for node selection before regulation methods are active and battery current is steadily at 0 A, for example. ReadPower (power consumption) can always be available when the node 200 is running. For example, the system load 202 of a node 200 can consume 5000 W. Then this power consumption can be measured.

The node selector 603 can reselect nodes out of the plurality of nodes to be activated and/or deactivated for the power grid frequency balancing according to the power quantity database 605.

In some embodiments, the frequency balancing capacity database 602 and the power quantity database 605 may be embodied in a single database. For example, the frequency balancing capacity data and the power quantity data may be stored in separate data structure, such as tables, in the single database.

FIG. 7 illustrates a schematic representation of a computing device according to an embodiment.

According to an embodiment, a computing device 700 comprises at least one processor 701 and at least one memory 702 including computer program code, the at least one memory 702 and the computer program code configured to, with the at least one processor 701, cause the computing device 700 to perform the method 100.

The computing device 700 may comprise at least one processor 701. The at least one processor 701 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The computing device 700 may further comprise a memory 702. The memory 702 may be configured to store, for example, computer programs and the like. The memory 702 may comprise one or more volatile memory devices, one or more non-volatile memory devices, and/or a combination of one or more volatile memory devices and non-volatile memory devices. For example, the memory 702 may be embodied as magnetic storage devices (such as hard disk drives, magnetic tapes, etc.), optical magnetic storage devices, and semiconductor memories (such as mask ROM, PROM (programmable ROM), EPROM (erasable PROM), flash ROM, RAM (random access memory), etc. ).

The computing device 700 may further comprise other components not illustrated in the embodiment of FIG. 7. The computing device 700 may comprise, for example, an input/output bus for connecting the computing device 700 to other devices.

When the computing device 700 is configured to implement some functionality, some component and/or components of the computing device 700, such as the at least one processor 701 and/or the memory 702, may be configured to implement this functionality. Furthermore, when the at least one processor 701 is configured to implement some functionality, this functionality may be implemented using program code comprised, for example, in the memory.

The computing device 700 may be implemented at least partially using, for example, a computer, some other computing device, or similar.

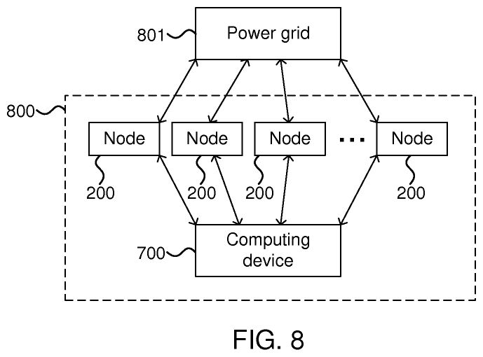

FIG. 8 illustrates a schematic representation of a distributed energy storage system according to an embodiment.

According to an embodiment, a distributed energy storage system 800 comprises the computing device 700 and a plurality of nodes 200 coupled to a power grid 801, wherein each node 200 comprises at least one energy storage.

Each node 200 in the plurality of nodes may be coupled to the computing device 700. Thus, the computing device 700 may be configured to control each node 200 in the plurality of nodes according to the method 100.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method for managing a distributed energy storage system comprising a plurality of nodes coupled to a power grid, wherein each node comprises at least one energy storage, the method comprising:
receiving an activation signal for power grid frequency balancing comprising a frequency balancing capacity requirement;
selecting nodes out of the plurality of nodes to be activated and/or deactivated for the power grid frequency balancing according to the frequency balancing capacity requirement;
activating and/or deactivating the selected nodes for the power grid frequency balancing;
monitoring during the power grid frequency balancing, whether a power quantity of the selected nodes deviates from the frequency balancing capacity requirement, wherein the power quantity is based on a measurement of the at least one energy storage of each node in the selected nodes; and
in response to the power quantity deviating from the frequency balancing capacity requirement, reselecting nodes out of the plurality of nodes to be activated and/or deactivated for the power grid frequency balancing according to the frequency balancing capacity requirement.

2. The computer-implemented method according to claim 1, wherein the power quantity deviating from the frequency balancing capacity requirement comprises a deviation between the power quantity and the frequency balancing capacity requirement being greater than a preconfigured deviation threshold value.

3. The computer-implemented method according to claim 1, wherein the selecting nodes out of the plurality of nodes to be activated and/or deactivated for the power grid frequency balancing according to the frequency balancing capacity requirement comprises:
selecting the nodes out of the plurality of nodes according to a frequency balancing capacity of each node in the plurality of nodes.

4. The computer-implemented method according to claim 3, wherein the selecting the nodes out of the plurality of nodes according to the frequency balancing capacity of each node in the plurality of nodes comprises:
obtaining the frequency balancing capacity of each node in the plurality of nodes from a frequency balancing capacity database.

5. The computer-implemented method according to claim 1, wherein the reselecting nodes out of the plurality of nodes to be activated and/or deactivated for the power grid frequency balancing according to the frequency balancing capacity requirement comprises:
in response to an aggregate of the power quantity of the selected nodes being less than the frequency balancing capacity requirement, increasing a number of nodes in the selected nodes; and/or
in response to an aggregate of the power quantity of the selected nodes being greater than the frequency balancing capacity requirement, decreasing a number of nodes in the selected nodes.

6. The computer-implemented method according to claim 1, wherein the monitoring whether the power quantity of the selected nodes deviates from the frequency balancing capacity requirement comprises obtaining the power quantity of each node in the selected nodes from a power quantity database.

7. The computer-implemented method according to claim 1, wherein the at least one energy storage comprises at least one battery.

8. The computer-implemented method according to claim 1, wherein the activating and/or deactivating the selected nodes for the power grid frequency balancing comprises:
in response to the frequency balancing capacity requirement corresponding to up regulation of the power grid, powering each node of the selected nodes using the at least one energy storage of the node and/or feeding power to the power grid from the at least one energy storage of the node; and/or
in response to the frequency balancing capacity requirement corresponding to down regulation of the power grid, charging the at least one energy storage of each node in the selected nodes using power from the power grid.

9. The computer-implemented method according to claim 1, wherein:
each node in the plurality of nodes comprises a rectifier for charging the at least one energy storage using power from the power grid; and/or
each node in the plurality of nodes comprises an inverter for feeding power to the power grid from the at least one energy storage.

10. The computer-implemented method according to claim 1, wherein the power quantity comprises a current and a voltage of at least one energy storage.

11. The computer-implemented method according to claim 1, wherein the power quantity comprises a product of a current and a voltage of at least one energy storage.

12. A computing device comprising at least one processor and at least one memory including computer program code, the at least one memory and the computer program code configured to, with the at least one processor, cause the computing device to perform the method according to claim 1.

13. A distributed energy storage system comprising the computing device according to claim 12 and a plurality of nodes coupled to a power grid, wherein each node comprises at least one energy storage.

14. A computer program product comprising program code configured to perform the method according to claim 1 when the computer program product is executed on a computer.
